(19) United States
(12) Patent Application Publication
(10) Pub. No.: US 2024/0097391 A1
(43) Pub. Date: Mar. 21, 2024

(54) APPARATUS FOR WIRE-CONTACT INSERTION AND ASSOCIATED SYSTEM AND METHOD

(71) Applicant: The Boeing Company, Chicago, IL (US)

(72) Inventor: Constantine N. Cooper, St. Louis, MO (US)

(21) Appl. No.: 17/948,485

(22) Filed: Sep. 20, 2022

(51) Int. Cl. H01R 43/22

(52) U.S. Cl. CPC H01R 43/22

(57) ABSTRACT

An apparatus for inserting a wire contact into an object is disclosed. The apparatus comprising a handle portion and a trigger slidably engaged with the handle portion. The apparatus also comprises an inner tube comprising an inner-tip end that is fixed to the handle portion. The apparatus further comprises an outer tube comprising an outer-tip end that is concentric with and slidably moveable relative to the inner tube. The outer tube is fixed to the trigger. The trigger is configured to move along the handle portion between, and inclusive of, a first position and a second position. When the trigger is in the first position, the inner-tip end of the inner tube is retracted within the outer tube. Alternatively, when the trigger is in the second position, the inner-tip end of the inner tube is extended from the outer-tip end of the outer tube.

### FIELD

This disclosure relates generally to a component insertion apparatus, and more particularly to an apparatus for inserting a wire contact into an object.

### BACKGROUND

Electrical connector components, such as terminal blocks, are often used for joining two or more wires or sections of electronic circuits in industrial applications, such as aircraft, spacecraft, and the like. By either hand-wiring or using a conventional tool, a wire can be inserted into a wire-securing receptacle on the connector component. However, hand-wiring or the use of conventional tools can result in mis-insertions of the wire, such that the wire is not fully seated within the connector component and not in complete electrical contact with the connector component. Often, mis-insertions go unnoticed until the connector component fails a process-testing at some later point, resulting in additional testing, time, and labor to determine which wire(s) is mis-inserted and to reseat or replace the wire. Additionally, conventional tools can accidentally pull a wire out of the wire-securing receptacle upon removal of the tool from the connector component, requiring the wire to be re-inserted, or replaced, in the case of wire damage caused by the accidental removal.

### SUMMARY

The subject matter of the present application has been developed in response to the present state of the art, and in particular, in response to the problems of and needs created or not yet fully solved by conventional wire contact apparatuses. Generally, the subject matter of the present application has been developed to provide wire contact apparatuses, and associated systems and methods, that overcome at least some of the above-discussed shortcomings of prior art systems.

Disclosed herein is an apparatus for inserting a wire contact into an object. The apparatus comprises a handle portion. The apparatus also comprises a trigger slidably engaged with the handle portion. The apparatus further comprises an inner tube comprising an inner-tip end that is open and has an exterior diameter. The inner tube is fixed to the handle portion, such that the inner tube does not move relative to the handle portion. Additionally, the apparatus comprises an outer tube that is concentric with and slidably movable relative to the inner tube and comprises an outer-tip end that is open and has an interior diameter. The interior diameter of the outer-tip end is greater than the exterior diameter of the inner-tip end. The outer tube is fixed to the trigger, such that the outer tube does not move relative to the trigger. The trigger is configured to move along the handle portion between, and inclusive of, a first position and a second position. When the trigger is in the first position, the inner-tip end of the inner tube is retracted within the outer tube. Alternatively, when the trigger is in the second position, the inner-tip end of the inner tube is extended from the outer-tip end of the outer tube. The preceding subject matter of this paragraph characterizes example 1 of the present disclosure.

The handle portion further comprises a handle having a distal end and a proximal end, that is opposite of the distal end, and an aperture passing through at least a portion of the handle from the proximal end. The handle portion also further comprises a strut slidably movable in the aperture and extending from the proximal end of the handle. The preceding subject matter of this paragraph characterizes example 2 of the present disclosure, wherein example 2 also includes the subject matter according to example 1, above.

The handle portion further comprises a spring surrounding at least a portion of the strut. The strut is configured to compress and decompress the spring as the trigger moves along the handle portion from the second position to the first position. The preceding subject matter of this paragraph characterizes example 3 of the present disclosure, wherein example 3 also includes the subject matter according to example 2, above.

The strut and the spring are integrally formed as a spring-loaded strut. The preceding subject matter of this paragraph characterizes example 4 of the present disclosure, wherein example 4 also includes the subject matter according to example 3, above.

The handle portion further comprises a tubular housing fixed to the proximal end of the handle, such that the tubular housing does not move relative to the handle. The tubular housing comprises an exterior surface, an interior surface, and at least one elongated slot extending entirely through the tubular housing from the exterior surface to the interior surface. The trigger comprises a pin and the trigger is slidably engaged with the exterior surface of the tubular housing and retained on the exterior surface via the pin, which extends through the at least one elongated slot. The preceding subject matter of this paragraph characterizes example 5 of the present disclosure, wherein example 5 also includes the subject matter according to any of examples 2-4, above.

The tubular housing is integrally formed with the handle. The preceding subject matter of this paragraph characterizes example 6 of the present disclosure, wherein example 6 also includes the subject matter according to example 5, above.

The pin and the strut are adjacent to each other, such that as the trigger moves along the handle portion, from the second position to the first position, the pin and the strut remain in contact. The preceding subject matter of this paragraph characterizes example 7 of the present disclosure, wherein example 7 also includes the subject matter according to any of examples 5-6, above.

The outer tube has an outer-tube opening extending from the outer-tip end along a portion of a length of the outer tube. The outer tube is configured to grip an insert end of the wire contact with the outer-tip end. The inner tube has an inner-tube opening extending from the inner-tip end along a portion of a length of the inner tube. The outer-tube opening is concentric with the inner-tube opening such that when the outer-tip end is gripping the insert end of the wire contact, a wire, extending from the wire contact, exits through the outer-tube opening and the inner-tube opening. The preceding subject matter of this paragraph characterizes example 8 of the present disclosure, wherein example 8 also includes the subject matter according to any of examples 1-7, above.

The insert end of the wire contact has an insert diameter. The interior diameter of the outer-tip end is greater than the insert diameter. The exterior diameter of the inner-tip end is less than the insert diameter. The preceding subject matter of this paragraph characterizes example 9 of the present disclosure, wherein example 9 also includes the subject matter according to example 8, above.

The interior diameter of the outer-tip end is greater than or equal to 0.08 inches. The preceding subject matter of this paragraph characterizes example 10 of the present disclosure, wherein example 10 also includes the subject matter according to any of examples 1-9, above.

The exterior diameter of the inner-tip end is less than or equal to 0.08 inches. The preceding subject matter of this paragraph characterizes example 11 of the present disclosure, wherein example 11 also includes the subject matter according to any of examples 1-10, above.

The trigger comprises a finger grip that extends from an exterior surface of the trigger and is configured to assist a user when moving the trigger between, and inclusive of, the first position and the second position. The preceding subject matter of this paragraph characterizes example 12 of the present disclosure, wherein example 12 also includes the subject matter according to any of examples 1-11, above.

Further disclosed herein is a system for inserting a wire contact into an object. The system comprises an apparatus that comprises a handle portion and a trigger slidably engaged with the handle portion. The apparatus also comprises an inner tube comprising an inner-tip end that is open and has an exterior diameter, wherein the inner tube is fixed to the handle portion, such that the inner tube does not move relative to the handle portion. The apparatus further comprises an outer tube that is concentric with and slidably movable relative to the inner tube and comprises an outer-tip end that is open and has an interior diameter. The interior diameter of the outer-tip end is greater than the exterior diameter of the inner-tip end. The outer tube is fixed to the trigger, such that the outer tube does not move relative to the trigger. The trigger is configured to move along the handle portion between, and inclusive of, a first position and a second position. When the trigger is in the first position, the inner-tip end of the inner tube is retracted within the outer tube. Alternatively, when the trigger is in the second position, the inner-tip end of the inner tube is extended from the outer-tip end of the outer tube. The system also comprises the wire contact comprising an insert end and a terminal-contact end, that is opposite of the insert end, and a wire extending from the insert end. The system further comprises a terminal block comprising a plurality of wire-securing receptacles. The preceding subject matter of this paragraph characterizes example 13 of the present disclosure.

A force between, and inclusive of, four to six pounds is required to fully seat the terminal-contact end of the wire contact into one of the plurality of wire-securing receptacles. The preceding subject matter of this paragraph characterizes example 14 of the present disclosure, wherein example 14 also includes the subject matter according to example 13, above.

A force between, and inclusive of, three to five pounds is required to remove the outer tube from the insert end of the wire contact after the wire contact is fully seated in the one of the plurality of wire-securing receptacles. The preceding subject matter of this paragraph characterizes example 15 of the present disclosure, wherein example 15 also includes the subject matter according to any of examples 12-14, above.

The outer tube is removably fixed to the trigger. The inner tube is removably fixed to the handle portion. The system further comprises a second inner tube having a second inner-tip end that is open and has a second exterior diameter. The second inner tube is configured to be removably fixable to the handle portion, such that the second inner tube does not move relative to the handle portion when the second inner tube is fixed to the handle portion. The system further comprises a second outer tube having a second outer-tip end that is open and has a second interior diameter. The second interior diameter of the second outer-tip end is greater than the second exterior diameter of the second inner-tip end. Additionally, the second outer tube is configured to be removably fixed to the trigger, such that the second outer tube does not move relative to the trigger and is slidably movable relative to the second inner tube when the second outer tube is fixed to the trigger. The outer tube is configured to be replaceable with the second outer tube. The second interior diameter of the second outer-tip end is different than the interior diameter of the outer-tip end of the outer tube. The inner tube is configured to be replaceable with the second inner tube. The second exterior diameter of the second inner-tip end is different than the exterior diameter of the inner-tip end of the inner tube. The preceding subject matter of this paragraph characterizes example 16 of the present disclosure, wherein example 16 also includes the subject matter according to any of examples 13-15, above.

The insert end of the wire contact has an insert diameter. The interior diameter of the outer-tip end is greater than the insert diameter. The exterior diameter of the inner-tip end is less than the insert diameter. The preceding subject matter of this paragraph characterizes example 17 of the present disclosure, wherein example 17 also includes the subject matter according to any of examples 13-16, above.

Further disclosed herein is a method of inserting a wire contact into an object. The method comprises gripping an insert end of the wire contact with an outer-tip end of an outer tube of an apparatus. The outer-tip end being open and having an interior diameter that is greater than an insert diameter of the insert end of the wire contact. The outer tube fixed to a trigger. When the insert end of the wire contact is gripped with the outer-tip end of the outer tube the method also comprises, inserting the wire contact into one of a plurality of wire-securing receptacles of a terminal block. This is done, in an insertion direction, by moving the apparatus relative to the terminal block, until a terminal-contact end of the wire contact, opposite of the insert end, is fully seated within the one of the plurality of wire-securing receptacles. When the insert end of the wire contact is gripped with the outer-tip end of the outer tube and the terminal-contact end is fully seated within the one of the plurality of wire-securing receptacles the method further comprises, pinning an inner-tip end of an inner tube of the apparatus against the insert end of the wire contact. Additionally, the method comprises sliding the trigger along a handle portion of the apparatus, in an extraction direction, opposite of the insertion direction until the outer-tip end of the outer tube is ungripped from the insert end of the wire contact and removed from the one of the plurality of wire-securing receptacles. The preceding subject matter of this paragraph characterizes example 18 of the present disclosure.

The step of inserting the wire contact into one of the plurality of wire-securing receptacles comprises applying a force between, and inclusive of, four to six pounds to the trigger, in the insertion direction, to fully seat the terminal-contact end of the wire contact into the one of the plurality of wire-securing receptacles. The preceding subject matter of this paragraph characterizes example 19 of the present disclosure, wherein example 19 also includes the subject matter according to example 18, above.

The step of sliding the trigger along a handle portion of the apparatus comprises applying a force between, and inclusive of, three to five pounds to the trigger, in the extraction direction, after the wire contact is fully seated in the one of the plurality of wire-securing receptacles. The preceding subject matter of this paragraph characterizes example 20 of the present disclosure, wherein example 20 also includes the subject matter according to any of examples 18-19, above.

The described features, structures, advantages, and/or characteristics of the subject matter of the present disclosure may be combined in any suitable manner in one or more examples, including embodiments and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example, embodiment, or implementation. In other instances, additional features and advantages may be recognized in certain examples, embodiments, and/or implementations that may not be present in all examples, embodiments, or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific examples that are illustrated in the appended drawings. Understanding that these drawings depict only typical examples of the subject matter, they are not therefore to be considered to be limiting of its scope. The subject matter will be described and explained with additional specificity and detail through the use of the drawings, in which:

FIG. 1 is a schematic, perspective view of an apparatus for inserting a wire contact into an object, the apparatus in a first position, according to one or more examples of the present disclosure;

FIG. 2 is a schematic, perspective view of the apparatus, in a second position, according to one or more examples of the present disclosure;

FIG. 3 is a schematic, exploded view of the apparatus, according to one or more examples of the present disclosure;

FIG. 4 is a schematic, cross-sectional view of the apparatus, in the first position, according to one or more examples of the present disclosure;

FIG. 5 is a schematic, cross-sectional view of the apparatus, in the first position, according to one or more examples of the present disclosure;

FIG. 6 is a schematic, cross-sectional view of the apparatus, in the second position, according to one or more examples of the present disclosure;

FIG. 7 is a schematic, perspective view of the apparatus, with interchangeable outer tubes and inner tubes, according to one or more examples of the present disclosure;

FIG. 8 is a schematic, perspective view of a system for inserting a wire contact into an object, the apparatus gripping a wire contact, according to one or more examples of the present disclosure;

FIG. 9 is a schematic, perspective view of the system of FIG. 7 inserting the wire contact into one of a plurality of wire-securing receptacles of a terminal block, according to one or more examples of the present disclosure;

FIG. 10 is a schematic, perspective view of the system of FIG. 7, the terminal block having a partial cutaway view, the wire contact seated within one of the plurality of wire-securing receptacles of the terminal block, according to one or more examples of the present disclosure; and

FIG. 11 is a schematic flow diagram of a method of inserting a wire contact into an object, according to one or more examples of the present disclosure.

### DETAILED DESCRIPTION

Reference throughout this specification to “one example,” “an example,” or similar language means that a particular feature, structure, or characteristic described in connection with the example is included in at least one example of the subject matter of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the subject matter of the present disclosure, however, absent an express correlation to indicate otherwise, an implementation may be associated with one or more examples.

Disclosed herein is an apparatus, system, and method for inserting a wire contact into an object that provides an improvement to the conventional wire insertion apparatus. Conventional insertion tools, for example, can result in the mis-insertion of the wire into the wire-securing receptable by failing to fully seat the wire upon insertion or accidentally pulling the wire partially or completely out of the wire-securing receptacle upon removal of the conventional insertion tool. In certain examples, the below described examples provide an improved mechanical apparatus which can grip a wire contact, as well as, pin a wire contact within a wire-securing receptacle while removing the apparatus from the object, to better ensure that the wire contact is fully seated within the object and the apparatus is properly removed from the wire contact.

The apparatus described herein may be employed during any one of the steps of manufacturing, assembly, and repair of the electrical system of an aircraft. However, the principles of the present disclosure may be applied to other industries, such as the automotive assembly industry, or any industry that utilizes wiring for manufacturing, assembly, and/or repair.

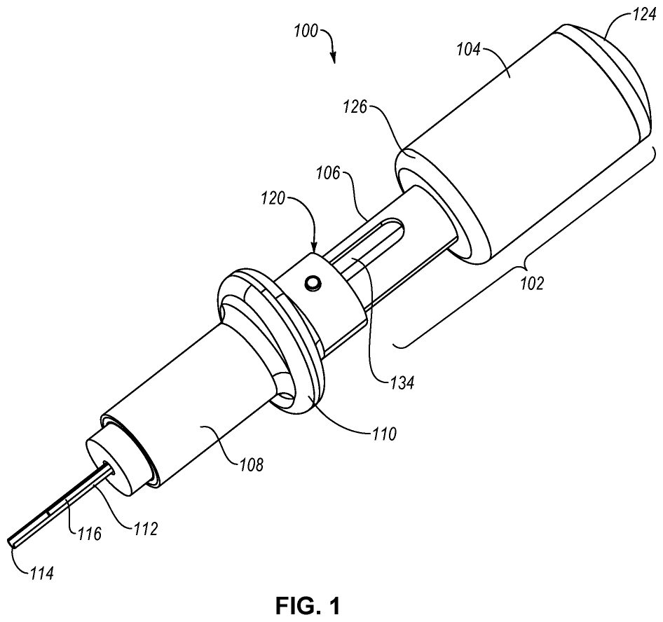

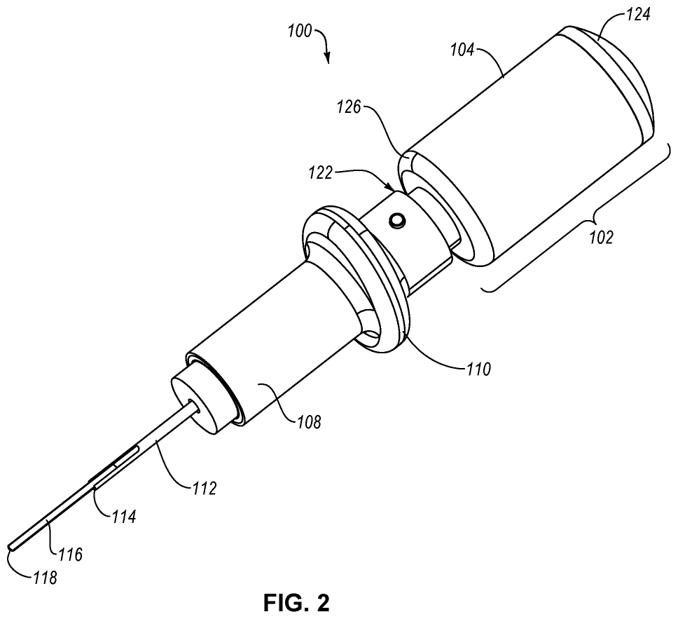

Referring to FIGS. 1-2, a perspective view of an apparatus 100 for inserting a wire contact into an object is shown. The apparatus 100 includes a handle portion 102, which, in some examples, includes a handle 104 and a tubular housing 106. The handle 104 has a distal end 124 and a proximal end 126, that is opposite of the distal end 124. The tubular housing 106 is fixed to the proximal end 126 of the handle 104, such that the tubular housing 106 does not move relative to the handle 104. In some examples, the tubular housing 106 and the handle 104 are integrally formed as a single unit. In other examples, the handle 104 and tubular housing 106 are fixed together by any attachment mechanism, such as adhesive, soldering, screws, threaded engagement, etc. The distal end 124 of the handle 104, in some examples, has an ergonomic design to improve the comfort of a user during use the apparatus 100. For example, the distal end 124 may have a concave surface configured to fit a thumb of a user. Alternatively, or additionally, the distal end 124 may have a textured surface to help improve the grip of thumb of the user on the distal end 124 of the handle 104.

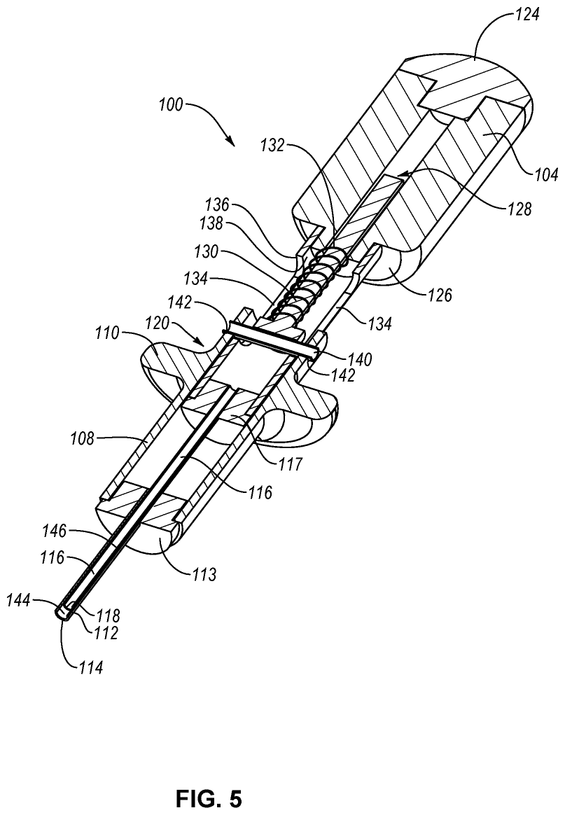

The tubular housing 106 has at least one elongated slot 134 that extends entirely through the tubular housing 106 from an exterior surface 136 to an interior surface 138. In some examples, the tubular housing 106 has two elongated slots 134, having an equal size and shape and aligned with each other on opposite sides of the tubular housing 106 (see, e.g., FIG. 5).

The apparatus 100 also includes a trigger 108 that is slidable engaged with the handle portion 102. More specifically, the trigger 108 is slidably engaged with the exterior surface 136 of the tubular housing 106. The trigger 108 is retained on the exterior surface 136 of the tubular housing 106 via a pin 140. The pin 140 extends from the trigger 108 and through the at least one elongated slot 134. Additionally, the pin 140 is configured to slide within the at least one elongated slot 134, as the trigger is moved relative to the handle portion 102. In some examples, the trigger 108 includes a finger grip 110 that extends from an exterior surface of the trigger 108. The finger grip 110 is configured to assist a user in moving the trigger 108 relative to the handle portion 102. The finger grip may have an ergonomic design, such as at least one concave area configured to fit a finger of a user, so as to improve the comfort of the user during use of the apparatus 100.

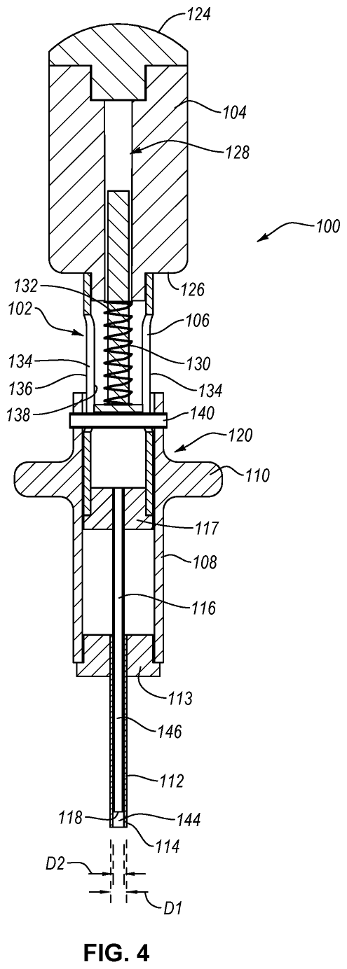

An outer tube 112 is fixed to the trigger 108, such that the outer tube 112 does not move relative to the trigger 108. In other words, as the trigger 108 is moved, relative to the handle portion 102, the outer tube 112 is also moved relative to the handle portion 102. The outer tube 112 has an outer-tip end 114 that is open and has an interior diameter D1 (see, e.g., FIG. 4). The outer-tip end 114 is configured to grip an insert end of a wire contact, as such the interior diameter D1 is sized and shaped to securely grip the insert end during use of the apparatus 100. In some examples, the interior diameter D1 of the outer-tip end 114 is greater than or equal to 0.08 inches.

An inner tube 116 is fixed to the handle portion 102, such that the inner tube 116 does not move relative to the handle portion 102. The inner tube 116 has an inner-tip end 118 that is open and has an exterior diameter D2 (see, e.g., FIG. 4). The inner-tip end 118 is configured to pin the insert end of the wire contact in an object during removal of the apparatus 100 from the object. Accordingly, the exterior diameter D2 is sized and shaped to securely pin the insert end during use of the apparatus 100. In some examples, the exterior diameter D2 of the inner-tip end 118 is less than or equal to 0.08 inches. The inner tube 116 is concentric with and fitted within the outer tube 112, such that the exterior diameter D2 of the inner-tip end 118 is less than the interior diameter D1 of the outer-tip end 114, and the outer tube 112 is slidably movable relative to the inner tube 116.

The trigger 108 is configured to move along the handle portion 102 between, and inclusive of, a first position 120, as shown in FIG. 1, and a second position 122, as shown in FIG. 2. When the trigger 108 is in the first position 120, the inner-tip end 118 of the inner tube 116 is retracted within the outer tube 112. That is, while in the first position 120, the outer-tip end 114 of the outer tube 112 extends away from the inner-tip end 118 and is capable of gripping the insert end of a wire contact without interference from the inner tube 116. In other words, the inner tube 116 is sufficiently retracted within the outer tube 112 to avoid interfering with the secure grip between the wire contact and the outer-tip end 114 of the outer tube 112. When the trigger 108 is in the second position 122, the inner-tip end 118 of the inner tube 116 is extended from the outer-tip end 114 of the outer tube 112.

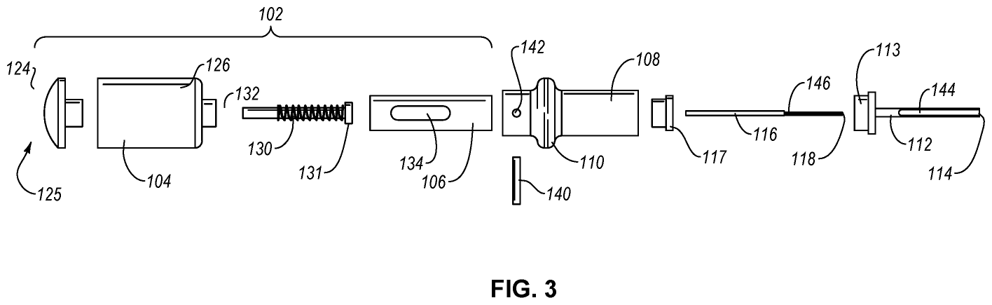

An exploded view of the apparatus 100 of FIGS. 1-2 is shown in FIG. 3. The handle portion 102 also includes a strut 130 that is slidably movable in an aperture (see, e.g., FIG. 4) of the handle 104. In one example, the spring 132 surrounds the strut 130 and is positioned within the tubular housing 106. As the trigger 108 is moved from the first position 120 to the second position 122, the spring 132 is compressed between a base 131 of the strut 130 and the proximal end 126 of the handle 104. In some cases, the handle 104 and tubular housing 106 are removably fixed, such that the proximal end 126 of the handle and the 106 tubular housing are attached by screws, threaded engagement, or other removable attachment means. Accordingly, the handle 104 and the tubular housing 106 can be detached in order to repair or replace the spring 132 and/or strut 103. In another example, a spring 132 is within the aperture of the handle and the strut 130 is configured to compress and decompress the spring as the trigger 108 moves along the handle portion 102 from the second position 122 to the first position 120 (see, e.g., FIGS. 4-6). The strut 130 and the spring 132 can be distinct parts. However, in other examples, the strut 130 and spring 132 are integrally formed as a spring-loaded strut, such that the strut 130 and the spring 132 have a one-piece, unitary, and seamless construction.

In some examples, the handle 104 includes a handle cap 125. The handle cap 125 may be permanently fixed to the handle 104 or removably fixed to the handle 104. In the latter case, the handle cap 125 can be removed for repairing or replacing the spring 132 or strut 130, rather than replacing the entire apparatus 100. In other examples, the handle 104 is formed as a single unit, without a separate handle cap.

The inner tube 116, in some examples, is fixed to the handle portion 102 via an inner cap 117 with the inner tube 116 fixed to the inner cap 117. The inner cap 117 is configured to be attachable to the interior surface 138 of the tubular housing 106, below the at least one elongated slot 134. Likewise, the outer tube 112, in some examples, is fixed to the trigger 108 via an outer cap 113 with the outer tube 112 fixed to the outer cap 113. The outer cap 113 is configured to be attachable to the interior surface of the trigger 108. In some examples, the inner cap 117 and the outer cap 113 are removably attached to the apparatus 100.

Additionally, the inner tube 116 has an inner-tube opening 146 extending from the inner-tip end 118 along a portion of a length of the inner tube 116. Likewise, the outer tube 112 has an outer-tube opening 144 extending from the outer-tip end 114 along a portion of a length of the outer tube 112. The inner-tube opening 146 and the outer-tube opening 144 are concentric and remain aligned during use of the apparatus, such that a wire, extending from a wire contact, can exit through the inner-tube opening 146 and the outer-tube opening 144.

Referring to FIGS. 4-5, a cross-sectional view of the apparatus 100 in the first position 120 is shown. The spring 132 is not shown in cross section for clarity in illustrating the features of the spring 132. The handle 104 includes an aperture 128 extending into at least a portion of the handle 104 from the proximal end 126 of the handle 104. The strut 130 is slidably movable in the aperture 128 while the base 131 of the strut 130 extends from the proximal end 126 of the handle 104 and outside of the aperture 128. The strut 130 is configured to compress and decompress the spring 132, which may be located within the aperture 128 or alternatively, surrounding the strut 130 and located in the tubular housing 106. When the trigger 108 is in the first position 120, the trigger 108 is not actuated and the spring 132 is in a decompressed state.

The pin 140 extends from the trigger 108 and through the two elongated slots 134, located on opposite sides of the tubular housing 106. When the trigger 108 is in the first position 120, the strut 130 and the pin 140 are adjacent (i.e., in contact) to each other. As the trigger 108 is actuated and moves along the exterior surface 136 of the tubular housing 106, the pin 140 and the strut 130 remain in contact. In other words, as the pin 140 slides along the two elongated slots 134, the strut 130 is moved, relative to the handle 104, into the aperture 128 and the spring 132 is compressed.

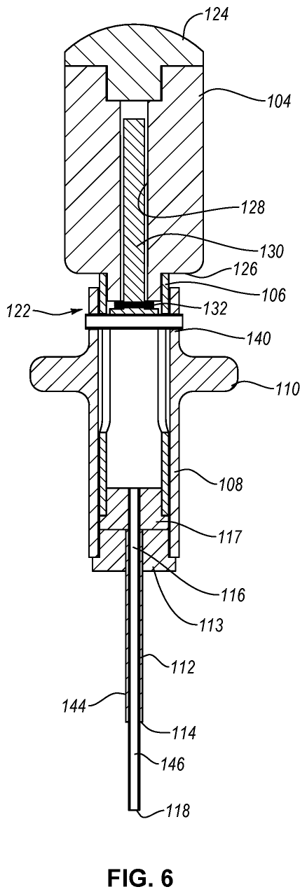

Referring to FIG. 6, a cross-section view of the apparatus 100 in the second position 122 is shown. When the trigger 108 is in the second position 122, the trigger 108 is actuated, and therefore the spring 132 is in a compressed state. As the trigger 108 was moved from the first position 120 to the second position 122, the pin 140 moved the strut 130, relative to the handle 104, into the aperture 128 to compress the spring 132. Additionally, this movement from the first position 120 to the second position 122, caused the inner-tip end 118 of the inner tube 116 to extend from the outer-tip end 114 of the outer tube 112.

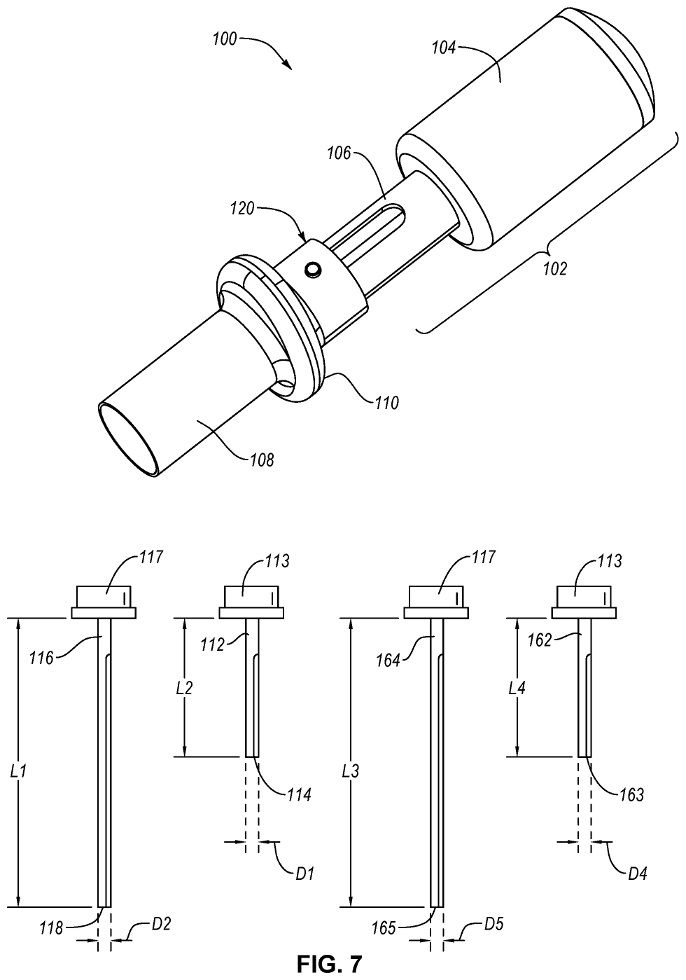

As shown in FIG. 7, in some examples, the apparatus 100 has interchangeable inner tubes and outer tubes. In order for the trigger 108 and handle portion 102 to be used with wire contacts 148 having different sizes, the apparatus 100 can have a modular configuration. The outer tube 112 is removably fixed to the trigger 108 and the inner tube 116 is removably fixed to the handle portion 102, such that both the outer tube 112 and the inner tube 116 can be removed from the apparatus 100 and replaced with other outer tubes and inner tubes. The apparatus 100 includes a second outer tube 162 that has a second outer-tip end 163 with a second interior diameter D4. The second interior diameter D4 is different from the interior diameter D1. In some examples, the second interior diameter D4 is larger than the interior diameter D1, in other examples, the second interior diameter D4 is smaller than the interior diameter D1. In either case, the second interior diameter D4 and the interior diameter D1 are appropriately sized, such that the diameter is greater than the insert diameter D3 of the corresponding insert end 150 of the wire contact 148. The outer tube 112 can be removed from the trigger 108 and replaced with the second outer tube 162.

Likewise, the apparatus 100 includes a second inner tube 164 that has a second inner-tip end 165 with a second exterior diameter D5. The second exterior diameter D5 is different from the exterior diameter D2. In some examples, the second exterior diameter D5 is larger than the interior diameter D2, in other examples, the second exterior diameter D5 is smaller than the exterior diameter D2. In either case, the second exterior diameter D5 and the exterior diameter D2 are appropriately sized, such that the diameter is less than the insert diameter D3 of the corresponding insert end 150 of the wire contact 148. The inner tube 116 can be removed from the handle portion 102 and replaced with the second inner tube 164.

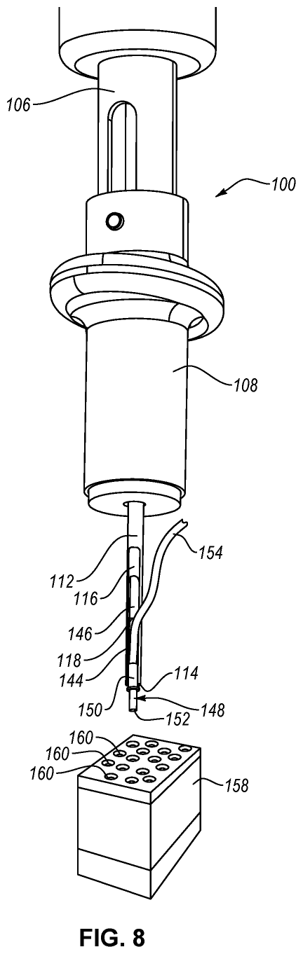

The outer tube 112 has a length L2 that is shorter than a length L1 of the inner tube 116. The length L2 of the outer tube 112 allows for the inner tube 116 to be retracted within the outer tube 112 when the apparatus 100 is in the first position 120. Additionally, the length L2 allows the inner tube 116 to extend from the outer-tube end 114 when the apparatus 100 is in the second position 122. For example, the length L2 of the outer tube 112 may be two inches and the length L1 of the inner tube may be three inches. In some examples, a length L4 of the second outer tube 162 is different than the length L2 of the outer tube 112. For example, the length L4 may be longer than the length L2. Likewise, in some examples, a length L3 of the second inner tube 164 is different than the length L1 of the inner tube 116. The length L4 of the second outer tube 162 and the length L3 of the second inner tube 164 may be different than the length L2 and the length L1, respectively, due to the size and shape of the wire contact 148 or due to the size of a wire-securing receptable and/or terminal block (see, e.g., FIG. 8).

A system 200 for inserting a wire contact 148 into an object is shown in FIGS. 8-10. The system includes the apparatus 100, a wire contact 148, and an object in which the wire contact 148 is configured to be inserted within. In some examples, the object is a connector component for joining two or more wires together, or joining sections of electronic circuits. For example, the connector component may be a terminal block, pin headers, DIN cable connectors, D-sub connectors, or industrial socket connectors. Although a terminal block 158 is referenced throughout, it should be understood that the apparatus 100 may be used for wire insertion with other connector components.

The terminal block 158 is an electrically conductive assembly having a plurality of wire-securing receptacles 160, which are often encased in a plastic housing. In order for a wire 154 to be in complete electrical contact with the terminal block 158, it is necessary for the wire contact 148 to be fully seated within one of the plurality of wire-securing receptacles 160. That is, the terminal-contact end 152 needs to be in electrical contact with the base of the corresponding one of the wire-securing receptacles 160. Failure to fully seat (i.e., mis-insert) the wire contact 148 results in the electrical current being negatively influenced or even interrupted. Such failures can often go unnoticed during the wiring process and are not discovered until the terminal block 158 fails a process-testing at a later point, resulting in additional time, labor, and testing to determine which wire contact 148 is not fully seated. To avoid issues with mis-insertions of the wire contact 148, the apparatus 100 is used to grip the wire contact 148 while inserting the wire contact into one of the wire-securing receptacles 160, as well as, pin the wire contact 148 within the wire-securing receptacle 160 while the apparatus 100 is ungripped from the wire contact 148 and removed from within the wire-securing receptacle 160.

As shown in FIG. 8, the insert end 150 of the wire contact 148 is gripped (i.e., tightly held) with the outer-tip end 114 of the outer tube 112. The interior diameter D1 of the outer-tip end 114 is greater than an insert diameter D3 of the insert end 150. That is, the interior diameter D1 is slightly larger than the insert diameter D3 so the outer-tip end 114 can grip the insert end 150 during the wire seating process. Therefore, the diameter of the outer-tip end 114 of the outer tube 112 corresponds with the diameter of the insert end 150 of the wire contact 148, such that the outer tube 112 of the apparatus 100 is sized specifically for the diameter of the insert end 150 of the wire contact 148. That is, a plurality of wire contacts 148 having different insert diameters D3 will either require multiple apparatus 100 each having an interior diameter D1 corresponding to one of the wire contacts 148, or an apparatus 100 with interchangeable outer tubes, which can be changed to correspond with the insert diameter D3 as shown in FIG. 7.

The apparatus 100 is in the first position 120, in which the inner-tip end 118 of the inner tube 116 is retracted within the outer tube 112. In other words, the inner-tip end 118 is not interfering with the grip of the outer-tip end 114 on the wire contact 148. The outer-tube opening 144, which extends from the outer-tip end 114 along a length of the outer tube 112 is aligned with the inner-tube opening 146, which extends from the inner-tip end 118 along a length of the inner tube 116. As such, the wire 154, which extends from the wire contact 148, can exit through the outer-tube opening 144 and the inner-tube opening 146.

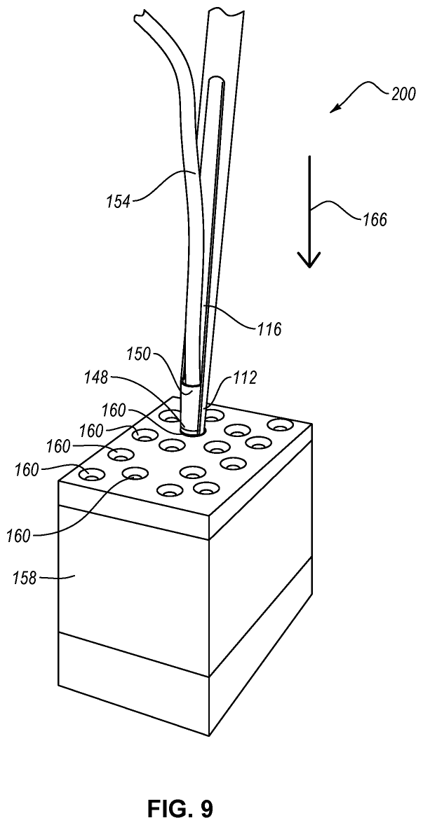

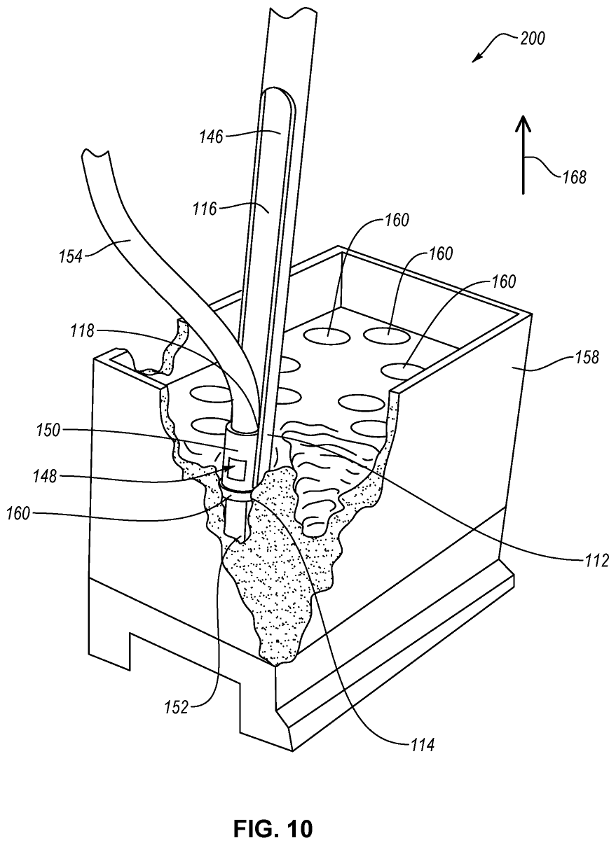

The gripped wire contact 148 is inserted into one of the plurality of wire-securing receptacles 160, in an insertion direction 166, as shown in FIG. 9. In some examples, a force, in the insertion direction 166, of less than ten pounds is required to fully seat the terminal-contact end 152 of the wire contact 148 within the one of the plurality of wire-securing receptacles 160. In other examples, a force between and inclusive of, four to six pounds is required to fully seat the terminal-contact end 152 of the wire contact 148 within the one of the plurality of wire-securing receptacles 160. The outer-tip end 114 of the outer tube 112 will extend slightly into either a housing of the terminal block 158 or directly into the wire-securing receptacle 160 when the wire contact is gripped by the outer-tip end 114 and fully seated within the wire-securing receptacle 160, as shown in FIG. 10. The terminal block 158, of FIG. 10, is shown with a partial cutaway view and the top housing removed to display the interior of one of the wire-securing receptacles 160 and the terminal-contact end 152 of the wire contact 148 fully seated within the wire-securing receptacles 160.

After the wire contact 148 is fully seated, the apparatus 100 can be removed from the wire contact 148. As the exterior diameter D2 of the inner-tip end 118 is less than the insert diameter D3 of the insert end 150, the inner-tip end 118 can be pinned against the insert end 150 of the wire contact 148. This is accomplished by actuating the trigger 108 to move from the trigger 108, in an extraction direction 168, from the first position 120 and sliding the pin 140 along the at least one elongated slot 134 until the inner-tip end 118 is tightly pinned against the insert end 150 of the wire contact 148. Once the inner-tip end 118 is pinned against the insert end 150 of the wire contact 148, the trigger 108 is further actuated to move the trigger 108, in the extraction direction 168, towards the second position 122. As the trigger 108 is actuated, the outer-tip end 114 is ungripped from the insert end 150 of the wire contact 148 while the pinning pressure, provided by the inner-tip end 118 against the insert end 150 of the wire contact 148, keeps the wire contact 148 fully seated within the wire-securing receptacle 160. In some examples, a force, in the extraction direction 168, of less than the force in the insertion direction 166 is required to release the wire contact 148 and extract the apparatus 100 from within the wire-securing receptacle 160. In other examples, a force between and inclusive of, three to five pounds is required to release the wire contact 148 and extract the apparatus 100 from with the wire-securing receptacle 160.

Once in the second position 122, the inner-tip end 118 of the inner tube 116 extends at least a distance from the outer-tip end 114 of the outer tube 112 that the outer-tip end 114 is entirely removed (i.e., no longer in contact) from the wire contact 148 while the inner-tip end 118 remains in contact with the insert end 150 of the wire contact 148. At this point, the apparatus 100 can be moved away from the wire contact 148 and wire 154 without the risk of unseating the wire contact 148 from the wire-securing receptacle 160.

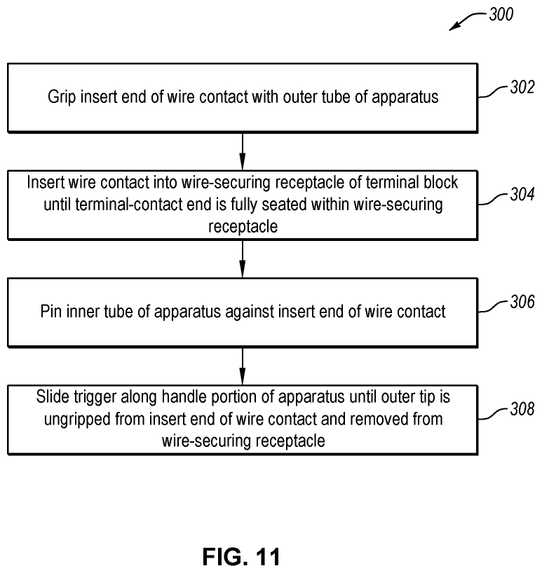

As shown in FIG. 11, according to some examples, a method 300 of inserting a wire contact 148 into an object with the system 200 of FIGS. 8-10 is shown. The method 300 includes the step of (block 302) gripping an insert end 150 of a wire contact 148 with an outer-tip end 114 of an outer tube 112 of an apparatus 100. The outer-tip end 114 being open and having an interior diameter D1 that is greater than an insert diameter D3 of the insert end 150 of the wire contact 148. The outer tube 112 is fixed to a trigger 108. When the insert end 150 of the wire contact 148 is gripped with the outer-tip end 114 of the outer tube 112, the method also includes the step of (block 304), inserting the wire contact 148 into one of a plurality of wire-securing receptacles 160 of a terminal block 158, in an insertion direction 166. This is accomplished by moving the apparatus 100 relative to the terminal block 158, until a terminal-contact end 152 of the wire contact 148, opposite of the insert end 150, is fully seated within the one of the plurality of wire-securing receptacles 160.

When the insert end 150 of the wire contact 148 is gripped with the outer-tip end 114 of the outer tube 112 and the terminal-contact end 152 is fully seated within the one of the plurality of wire-securing receptacles 160, the method further includes the step of (block 306), pinning an inner-tip end 118 of an inner tube 116 of the apparatus 100 against the insert end 150 of the wire contact 148. Additionally, the method includes the step of (block 308) sliding the trigger 108 along a handle portion 102 of the apparatus 100, in an extraction direction 168, opposite of the insertion direction 166 until the outer-tip end 114 of the outer tube 112 is ungripped from the insert end 150 of the wire contact 148 and removed from the one of the plurality of wire-securing receptacles 160.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.”

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The schematic flow chart diagrams included herein are generally set forth as logical flow chart diagrams. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present subject matter may be embodied in other specific forms without departing from its spirit or essential characteristics. The described examples are to be considered in all respects only as illustrative and not restrictive. All changes which come within the meaning and range of equivalency of the examples herein are to be embraced within their scope.

What is claimed is:

1. An apparatus for inserting a wire contact into an object, the apparatus comprising:
a handle portion;
a trigger slidably engaged with the handle portion;
an inner tube comprises an inner-tip end that is open and has an exterior diameter, wherein the inner tube is fixed to the handle portion, such that the inner tube does not move relative to the handle portion; and
an outer tube is concentric with and slidably movable relative to the inner tube and comprises an outer-tip end that is open and has an interior diameter, wherein the interior diameter of the outer-tip end is greater than the exterior diameter of the inner-tip end and the outer tube is fixed to the trigger, such that the outer tube does not move relative to the trigger;
wherein:
the trigger is configured to move along the handle portion between, and inclusive of, a first position and a second position;
when the trigger is in the first position, the inner-tip end of the inner tube is retracted within the outer tube; and
when the trigger is in the second position, the inner-tip end of the inner tube is extended from the outer-tip end of the outer tube.

2. The apparatus of claim 1, wherein the handle portion further comprises:
a handle having a distal end and a proximal end, opposite of the distal end, and an aperture passing through at least a portion of the handle from the proximal end; and
a strut slidably movable in the aperture and extending from the proximal end of the handle.

3. The apparatus of claim 2, wherein:
the handle portion further comprises a spring surrounding at least a portion of the strut; and
the strut is configured to compress and decompress the spring as the trigger moves along the handle portion from the second position to the first position.

4. The apparatus of claim 3, wherein the strut and the spring are integrally formed as a spring-loaded strut.

5. The apparatus of claim 2, wherein:
the handle portion further comprises a tubular housing fixed to the proximal end of the handle, such that the tubular housing does not move relative to the handle;
the tubular housing comprises an exterior surface, an interior surface, and at least one elongated slot extending entirely through the tubular housing from the exterior surface to the interior surface; and
the trigger comprises a pin, the trigger is slidably engaged with the exterior surface of the tubular housing and retained on the exterior surface via the pin, which extends through the at least one elongated slot.

6. The apparatus of claim 5, wherein the tubular housing is integrally formed with the handle.

7. The apparatus of claim 5, wherein the pin and the strut are adjacent to each other, such that as the trigger moves along the handle portion from the second position to the first position the pin and the strut remain in contact.

8. The apparatus of claim 1, wherein:
the outer tube has an outer-tube opening extending from the outer-tip end along a portion of a length of the outer tube;
the outer tube is configured to grip an insert end of the wire contact with the outer-tip end;
the inner tube has an inner-tube opening extending from the inner-tip end along a portion of a length of the inner tube; and
the outer-tube opening is concentric with the inner-tube opening such that when the outer-tip end is gripping the insert end of the wire contact, a wire, extending from the wire contact, exits through the outer-tube opening and the inner-tube opening.

9. The apparatus of claim 8, wherein:
the insert end of the wire contact has an insert diameter;
the interior diameter of the outer-tip end is greater than the insert diameter; and
the exterior diameter of the inner-tip end is less than the insert diameter.

10. The apparatus of claim 1, wherein the interior diameter of the outer-tip end is greater than or equal to 0.08 inches.

11. The apparatus of claim 1, wherein the exterior diameter of the inner-tip end is less than or equal to 0.08 inches.

12. The apparatus of claim 1, wherein the trigger comprises a finger grip that extends from an exterior surface of the trigger and is configured to assist a user when moving the trigger between, and inclusive of, the first position and the second position.

13. A system for inserting a wire contact into an object, the system comprising:
an apparatus comprising:
a handle portion;
a trigger slidably engaged with the handle portion;
an inner tube comprises an inner-tip end that is open and has an exterior diameter, wherein the inner tube is fixed to the handle portion, such that the inner tube does not move relative to the handle portion; and
an outer tube is concentric with and slidably movable relative to the inner tube and comprises an outer-tip end that is open and has an interior diameter, wherein the interior diameter of the outer-tip end is greater than the exterior diameter of the inner-tip end and the outer tube is fixed to the trigger, such that the outer tube does not move relative to the trigger;
wherein:
the trigger is configured to move along the handle portion between, and inclusive of, a first position and a second position;
when the trigger is in the first position, the inner-tip end of the inner tube is retracted within the outer tube; and
when the trigger is in the second position, the inner-tip end of the inner tube is extended from the outer-tip end of the outer tube;
the wire contact comprising an insert end and a terminal-contact end, opposite of the insert end, and a wire extending from the insert end; and
a terminal block comprising a plurality of wire-securing receptacles.

14. The system of claim 13, wherein a force between, and inclusive of, four to six pounds is required to fully seat the terminal-contact end of the wire contact into one of the plurality of wire-securing receptacles.

15. The system of claim 13, wherein a force between, and inclusive of, three to five pounds is required to remove the outer tube from the insert end of the wire contact after the wire contact is fully seated in the one of the plurality of wire-securing receptacles.

16. The system of claim 13, wherein:
the outer tube is removably fixed to the trigger;
the inner tube is removably fixed to the handle portion;
the system further comprises a second inner tube having a second inner-tip end that is open and has a second exterior diameter, wherein the second inner tube is configured to be removably fixable to the handle portion, such that the second inner tube does not move relative to the handle portion when the second inner tube is fixed to the handle portion;
the system further comprises a second outer tube having a second outer-tip end that is open and has a second interior diameter, wherein the second interior diameter of the second outer-tip end is greater than the second exterior diameter of the second inner-tip end, and the second outer tube is configured to be removably fixed to the trigger, such that the second outer tube does not move relative to the trigger and is slidably movable relative to the second inner tube when the second outer tube is fixed to the trigger;
the outer tube is configured to be replaceable with the second outer tube, wherein the second interior diameter of the second outer-tip end is different than the interior diameter of the outer-tip end of the outer tube; and
the inner tube is configured to be replaceable with the second inner tube, wherein the second exterior diameter of the second inner-tip end is different than the exterior diameter of the inner-tip end of the inner tube.

17. The system of claim 13, wherein:
the insert end of the wire contact has an insert diameter;
the interior diameter of the outer-tip end is greater than the insert diameter; and
the exterior diameter of the inner-tip end is less than the insert diameter.

18. A method of inserting a wire contact into an object, the method comprising:
gripping an insert end of the wire contact with an outer-tip end of an outer tube of an apparatus, the outer-tip end being open and having an interior diameter that is greater than an insert diameter of the insert end of the wire contact, the outer tube fixed to a trigger;
when the insert end of the wire contact is gripped with the outer-tip end of the outer tube, inserting the wire contact into one of a plurality of wire-securing receptacles of a terminal block, in an insertion direction, by moving the apparatus relative to the terminal block, until a terminal-contact end of the wire contact, opposite of the insert end, is fully seated within the one of the plurality of wire-securing receptacles;
when the insert end of the wire contact is gripped with the outer-tip end of the outer tube and the terminal-contact end is fully seated within the one of the plurality of wire-securing receptacles, pinning an inner-tip end of an inner tube of the apparatus against the insert end of the wire contact; and
sliding the trigger along a handle portion of the apparatus, in an extraction direction, opposite of the insertion direction until the outer-tip end of the outer tube is ungripped from the insert end of the wire contact and removed from the one of the plurality of wire-securing receptacles.

19. The method of claim 18, wherein the step of inserting the wire contact into one of the plurality of wire-securing receptacles comprises applying a force between, and inclusive of, four to six pounds to the trigger, in the insertion direction, to fully seat the terminal-contact end of the wire contact into the one of the plurality of wire-securing receptacles.

20. The method of claim 18, wherein the step of sliding the trigger along a handle portion of the apparatus comprises applying a force between, and inclusive of, three to five pounds to the trigger, in the extraction direction, after the wire contact is fully seated in the one of the plurality of wire-securing receptacles.
